(19) United States
(12) Patent Application Publication
(10) Pub. No.: US 2012/0311663 A1
(43) Pub. Date: Dec. 6, 2012

(54) IDENTITY MANAGEMENT

(75) Inventors: Robert Seidl, Konigsdorf (DE); Joerg Abendroth, Munich (DE); Gerald Meyer, Puchheim-Bhf (DE); Markus Bauer-Hermann, Munich (DE)

(73) Assignee: NOKIA SIEMENS NETWORKS OY, Espoo (FI)

(21) Appl. No.: 13/577,053

(22) PCT Filed: Feb. 5, 2010
(86) PCT No.: PCT/EP2010/051396

§ 371 Date: Aug. 3, 2012

(51) Int. Cl. G06F 21/00

(52) U.S. Cl. 726/1

(57) ABSTRACT

The present invention relates to an improved identity management in which a first authentication request is received from a service provider where the first authentication request requests authentication attributes relating to a user. A second authentication request is transmitted to an identity provider and a first authentication response is received from the identity provider wherein the first authentication response includes at least one authentication attribute relating to said user. At least one predefined policy is applied to the first authentication response to generate a second authentication response and the second authentication response is transmitted to the service provider.

The present invention relates to improving Identity Management.

More and more services and applications are becoming available on the Internet, and many of these services and applications require authentication of a user requesting the service. One approach that has been developed to assist users to access multiple services and applications, each requiring separate authentication procedures, involves the use of identity federation.

Federated identity management, or the “federation” of identity, describes technologies that serve to enable the portability of identity information across otherwise autonomous security domains. A goal of identity federation is to enable users of one domain to access data or systems of another domain seamlessly and securely, and without the need for redundant user administration. Eliminating the need for repeated login procedures each time a new application or account is accessed can substantially improve the user experience.

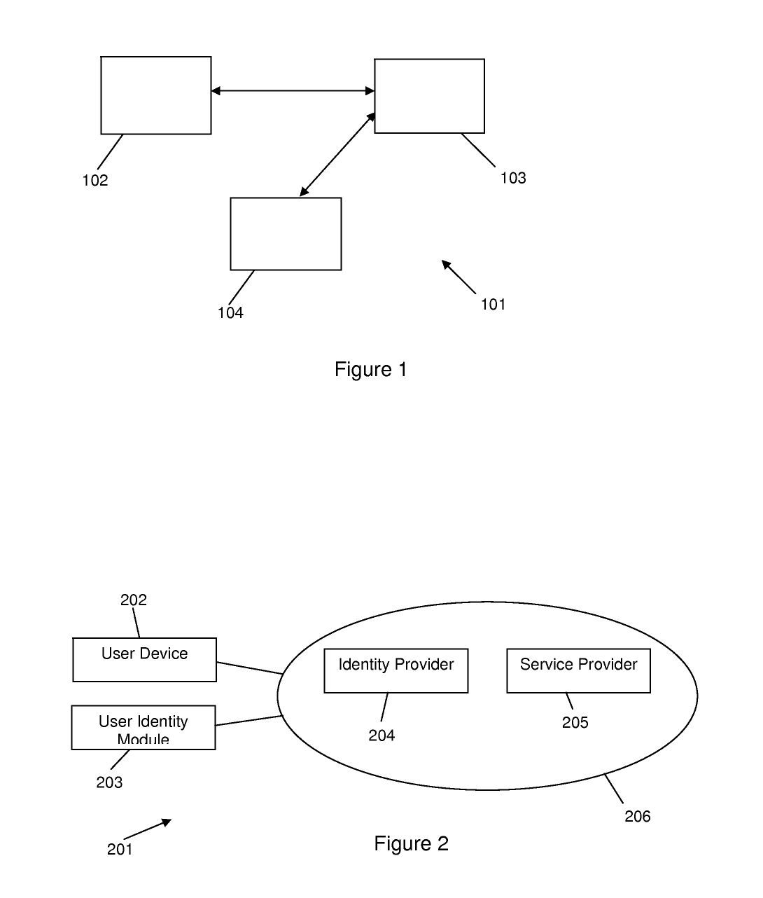

FIG. 1 is a block diagram demonstrating the concept of identity management. FIG. 1 shows a system, indicated generally by the reference numeral 101, comprising an end user 102, a service provider 103 and an identity provider 104. When the end user 102 of the system 101 wants to access a secure resource at the service provider 103, and the service provider 103 requires the user's identity to be authenticated, the identity provider 104 can be used to provide the required authentication information to the service provider.

The identity provider 104, which may be operated by a network operator, conventionally stores user authentication data, which typically includes personal and security sensitive data of all users 102 subscribed to the identity provider 104.

The user authentication data stored by the identity provider 104 is necessary to distinguish and authenticate users 102 with a service provider 103 for a particular service. The services offered by the service providers are various and many in number where the services require different levels of authentication of the identity of the user 102. For example, a simple social networking site will typically require only a username and password combination whilst an online banking service will typically require more secure and security sensitive data in order to authenticate the identity of the user 102.

Thus, the user authentication data stored at the identity provider 104 may include user's passwords and usernames along with more private data such as the user's address, date of birth, bank account data, and so on which are more security sensitive to the user, if that data is required by at least one service provider to authenticate the user for a particular service.

The user will therefore want to ensure that their user authentication data is secure and that only the data required to authenticate the user for a service is provided to the service provider 103. Access to certain data in the user's profile should be restricted and not provided to any service provider 103 that does not require the data in order to maintain adequate levels of privacy and security for the user 102.

Conventionally, an identity provider 104 will comprise mechanisms to enable a user 102 to define policies that specify the data or attributes from their user authentication data to be shared with particular service providers, other users or third parties. However, a problem with this approach is that a user does not know or can be absolutely positive that the defined policies will be enforced correctly by the identity provider 104, not modified by the identity provider 104 and that the service provider 103 does not request more data or attributes than is strictly necessary to authenticate the user to the service provider 103. It is also possible that particular authentication attributes requested by the service provider are not available at the identity provider. Thus, in conventional identity management systems the user's trust in the identity provider 104 is less than 100%.

A further mechanism for restricting access to a user's authentication data is that the identity provider implements a protocol which requests the user to authorise the access to the user's authentication data each and every time a third party, e.g. a service provider, requests or tries to access the user's data, in particular, the secure data.

In both cases, a problem is that the user has to trust the identity provider does not fine-grain or fine-tune the policies specified by the user. This is particularly important in the future as the functionalities and capabilities of the identity management systems are increasing which may enable the actors in the identity management system to be more autonomous and intuitive.

Another problem is that the identity provider 104 typically stores user authentication data for a user that are proven by a trusted authority or provided by a trusted authority. For example, the user's bank details may be proven by a bank or provided by a bank to the identity provider 104, the user's address or date of birth may be proven by a public agency or provided by a public agency and so on. However, in some circumstances for particular services the user may wish to enhance a request to a service provider 103 with additional data about the user which is not or cannot be authority proven but is simply user provided, for example, shoe size, job title, personal preferences, what channel the TV is on, if the computer is running, if the motion detector in the bathroom shows people in there and so on which the user may not wish to store at the identity provider or may not be available to store at the identity provider due to the changing nature of the data.

Therefore, in current identity management systems the user has no direct control over the exchange of data between the identity provider and the service provider. The user also cannot be completely satisfied that any polices defined at the identity provider are being enforced correctly and are not being altered by the identity provider so that the user's privacy is always maintained.

The present invention seeks to address at least some of the problems outlined above.

According to a first aspect of the present invention there is provided a method comprising the steps of: receiving a first authentication request for authentication attributes relating to a user wherein said first authentication request originates from a service provider; generating a first authentication response based on at least one predefined policy applied by a user identity module and at least one authentication attribute stored at an identity provider; and transmitting said first authentication response to said service provider in response to said first authentication request.

Accordingly, in many of the embodiments an authentication request is received from a service provider. The authentication request may request authentication attributes relating to a user so that the service provider can check the identity of the user requesting access or use of the service provided by the service provider. The service provider is typically any party that offers or provides services to a user. There are numerous and varying services that may be offered, for example, they may include social networking, communication (e.g. E-mail, messaging etc), online banking, online shopping and so on.

An authentication response to the service provider is then generated based on at least one predefined policy that is applied by a user identity module and at least one authentication attribute stored at an identity provider.

The at least one authentication attribute stored at the identity provider may be the authority proven attributes that are trusted by the service provider and used to authenticate the user requesting the service to the service provider.

The user identity module may be an electronic device attached to a user's home network, may be integrated with a network device, e.g. a router, on the user's home network or may be integrated with a user's device, e.g. a computer.

The at least one predefined policy may be defined by a user and stored at the user identity module. The predefined policies enable the user to define a policy, where the policy may include rules and/or instructions, which enable the user to control and/or enhance the authentication response transmitted to the service provider. The predefined policies may be applied when an authentication request is received from a particular service provider or for a particular service. The predefined policies may also be applied to all authentication requests received irrespective of the service and/or service provider.

The first authentication request may be received at said user identity module and the method further comprises the steps of: transmitting from said user identity module a second authentication request to said identity provider; receiving at said user identity module a second authentication response from said identity provider; applying in said user identity module at least one predefined policy to said second authentication response to generate said first authentication response; and transmitting from said user identity module said first authentication response to said service provider.

If the first authentication request originating from the service provider is received at the user identity module then the user identity module needs to obtain the authentication attributes relating to a user from the identity provider as the identity provider “owns” the authority proven and trusted authentication attributes relating to a user. Thus, the user identity module transmits a second authentication request to the identity provider in order to obtain the authentication attributes relating to the user which are relevant to the authentication request. The second authentication request may be the same as the first authentication request or the second authentication request may be different to the first authentication request.

The user identity module may then receive the second authentication response from the identity provider where the second authentication response may include at least one authentication attribute relating to the user that is relevant to the service and/or service provider. The user identity module may then apply at least one predefined policy to the second authentication response in order to generate the first authentication response which the user identity module transmits to the service provider.

The first authentication request may be received at said identity provider where the method further comprises the steps of: transmitting from said identity provider a second authentication request to said user identity module; applying in said user identity module said at least one predefined policy to said second authentication request to generate a second authentication response; transmitting from said user identity module said second authentication response to said identity provider; generating at said identity provider said first authentication response; and transmitting from said identity provider said first authentication response to said service provider.

If the first authentication request originating from the service provider is received at the identity provider then the identity provider may transmit a second authentication request to the user identity module. The second authentication request may be the same as the first authentication request or the second authentication request may be different to the first authentication request, for example, the second authentication request may include at least one authentication attribute relating to the user relevant to the requested service from the identity provider.

The user identity module may then apply at least one predefined policy to the second authentication request in order to generate a second authentication response which the user identity module transmits to the identity provider. The identity provider may then generate the first authentication response and transmit the first authentication response to the service provider.

The method may further comprise the steps of defining said at least one predefined policy; and storing said at least one predefined policy. Accordingly, the user may predefine and store the policies in the user identity module so that they can be applied when necessary to the relevant authentication requests originating from a service provider. The user may user a user device, such as a computer, to interact with the user identity module in order to create and define the policies.

The at least one predefined policy may insert at least one user profile attribute maintained by said user identity module. Thus, the authentication response generated to be transmitted to the service provider can be enhanced by inserting particular user profile attributes.

It may be useful to the user to be able provide further information or attributes relating to a user which are not typically for the purpose of authenticating the user to the service provider but may be useful for the service requested. Furthermore, by applying a predefined policy that may insert user profile data relating to a user automatically then the user may not need to enter the user profile attributes manually each and every time that the user requests and access the particular service. For example, if the user has registered for an online shopping service then the user may predefine a policy that inserts user profile attributes relating to the user's clothes size and shoe size so that this is known by the service without the need for the user to enter the user profile data manually. The user profile attributes may include any attribute relating to a user that is not or cannot be stored at the identity provider, for example, due to the nature of the user profile attributes which may include information that is dynamic or changes such as the current TV channel being viewed, the presence status of the user, location of the user and so on.

The method may further comprise the steps of defining at least one user profile attribute wherein said at least one user profile attribute is maintained by said user identity module; and storing said at least one user profile attribute.

Accordingly, the user may define at least one user profile attribute that may be maintained by the user identity module. The at least one user profile attribute may relate to any piece of information that the user may wish to store and/or maintain in order to enhance any authentication response to a service provider for a service that the user wishes to access. For example, the user profile attributes may relate to a user's shoe size, job title, current TV channel being viewed, security sensors and so on.

The defined user profile attributes are stored collectively as user profile data where one or more of the user profile attributes forming the user profile data may be relevant to any given service request. The user profile data may be stored in the user identity module or may be stored in a repository external to the user identity module where the user identity module can retrieve user profile attributes from the external repository. Thus, the user identity module may maintain the user profile data but does not necessarily store the user profile data itself. The user profile attributes stored may be encrypted in order to ensure the user's privacy and security.

The at least one user profile attribute may be a non-authority proven attribute and as such the service provider may decide whether to accept or trust the user profile attributes. However, as the user profile attributes are typically not for authentication of the user then the service provider may assume that the user profile attributes are correct and valid as the user would only want to provide correct and valid data. For example, if the user profile attribute relating to the user is the user's shoe size then the service provider may assume that the user will supply their correct shoe size and accept the inserted user profile attributes in the authentication response.

Accordingly, the user profile attributes are not typically used to authenticate the user to a service provider but may be used to enhance the information in the authentication response relating to the user that is provided to the service provider.

The at least one predefined policy may suppress at least one authentication attribute stored at said identity provider. Thus, as particular authentication attributes can be suppressed then this provides the user with control over the authentication attributes relating to the user stored at the identity provider that are transmitted and provided to a service provider. Accordingly, the user can be confident that the predefined polices can prevent authentication attributes the user does not wish to provide to the service and/or service provider from being transmitted to the service provider in the final authentication response.

Authentication attributes relating to the user stored at the identity provider may be suppressed in a number of ways.

For example, in the case that the user identity module obtains the at least one authentication attributes from the identity provider before applying at least one predefined policy then the at least one predefined policy may suppress one or more of those authentication attributes by removing or deleting the appropriate authentication attributes when generating the final authentication response to the service provider.

In the case that the user identity module applies the at least one predefined policy to an authentication request from the identity provider then the at least one predefined policy may include instructions or an indication to the identity provider (in response to the authentication response received from the identity provider) that one or more authentication attribute should not be included in the authentication response to be transmitted to the service provider by the identity provider.

Accordingly, a predefined policy may remove at least one authentication attribute, may insert at least one user profile attribute or may both remove at least one authentication attribute and also insert at least one user profile attribute. Thus, by applying at least one predefined policy the flow of data between the identity provider and the service provider can be supervised, monitored or moderated thereby ensuring that only the attributes relating to a user that the user wishes to provide to a particular service provider for a particular requested service is transmitted to the service provider.

The method may further comprise displaying the first authentication response and/or the second authentication response on a user device and receiving an approval input wherein if the approval input is negative then the method may further comprise the step of altering the first authentication response and/or the second authentication response based on the approval input. Therefore, the user is able to make the final decision as to the content of the authentication responses which further enhances the user's security and privacy. If the approval input is negative then the approval input may indicate which authentication attributes and/or user profile attributes that the user does not wish to transmit to the service provider and the authentication responses can be amended or altered accordingly based on the approval input.

According to a second aspect of the present invention there is provided a system comprising an identity provider and a user identity module wherein said identity provider and said user identity module are operatively connected; said system adapted to: receive a first authentication request for authentication attributes relating to a user wherein said authentication request originates from a service provider; generate a first authentication response based on at least one predefined policy applied by said user identity module and at least one authentication attribute stored at said identity provider; and transmit said first authentication response to said service provider in response to said authentication request.

The system may be further adapted to receive said first authentication request at said user identity module; transmit from said user identity module a second authentication request to said identity provider; receive at said user identity module a second authentication response from said identity provider; apply in said user identity module at least one predefined policy to said second authentication response to generate said first authentication response; and transmit from said user identity module said first authentication response to said service provider.

The system may be further adapted to receive said first authentication request at said identity provider; transmit from said identity provider a second authentication request to said user identity module; apply in said user identity module said at least one predefined policy to said second authentication request to generate a second authentication response; transmit from said user identity module said second authentication response to said identity provider; generate at said identity provider said first authentication response; and transmit from said identity provider said first authentication response to said service provider.

According to a third aspect of the present invention there is provided a method comprising the steps of: receiving a first authentication request from a service provider wherein said first authentication request requests authentication attributes relating to a user; transmitting a second authentication request to an identity provider; receiving a first authentication response from said identity provider wherein said first authentication response includes at least one authentication attribute relating to said user; applying at least one predefined policy to said first authentication response to generate a second authentication response; and transmitting said second authentication response to said service provider in response to said first authentication request.

A first authentication request may be received from a service provider requesting authentication attributes relating to a user so that the service provider may check that the identity of the person requesting access or use of the service provided by the service provider. A second authentication request may then be transmitted to an identity provider to obtain the relevant authentication attributes for the requested service as the identity provider may own the authentication attributes relating to the user. The second authentication request transmitted to the identity provider may be identical to the first authentication request received from the service provider or the second authentication request may be altered, amended or edited prior to transmitting it to the identity provider.

A first authentication response may be received from the identity provider which includes at least one authentication attribute relating to the user relevant to the requested service. The authentication attributes forming at least part of the first authentication response may be digitally signed individually, digitally signed in at least one group of authentication attributes or not digitally signed by the identity provider. At least one predefined policy is applied to the received first authentication response in order to generate a second authentication response which will be transmitted to the service provider. The predefined policies are the same as those described hereinabove and thus provide the ability to suppress at least one authentication attribute, may insert at least one user profile attribute or may both suppress at least one authentication attribute and also insert at least one user profile attribute. The authentication attributes and user profile attributes are the same as those described hereinabove.

The step of applying at least one predefined policy to said first authentication response may comprise the step of suppressing at least one authentication attribute. The step of applying at least one predefined policy to said first authentication response may comprise the step of inserting at least one user profile attribute.

The method may further comprise the steps of defining at least one user profile attribute; and storing said at least one user profile attribute. The method may further comprise the steps of: defining said at least one predefined policy; and storing said at least one predefined policy.

The method may further comprise the steps of displaying said generated second authentication response on a user device prior to transmitting said second authentication response to said service provider; and receiving an approval input wherein if said approval input is negative then said method further comprises the step of altering said second authentication response based on said approval input.

The method may be performed by a user identity module.

According to a fourth aspect of the present invention there is provided an apparatus comprising a first input adapted to receive a first authentication request from a service provider wherein said first authentication request requests authentication attributes relating to a user; a first output adapted to transmit a second authentication request to an identity provider; a second input adapted to receive a first authentication response from said identity provider wherein said first authentication response includes at least one authentication attribute relating to said user; a first processor adapted to apply at least one predefined policy to said first authentication response to generate a second authentication response; and a second output adapted to transmit said second authentication response to said service provider.

According to a fifth aspect of the present invention there is provided an apparatus adapted to: receive a first authentication request from a service provider wherein said first authentication request requests authentication attributes relating to a user; transmit a second authentication request to an identity provider; receive a first authentication response from said identity provider wherein said first authentication response includes at least one authentication attribute relating to said user; apply at least one predefined policy to said first authentication response to generate a second authentication response; and transmit said second authentication response to said service provider in response to said first authentication request.

The first processor adapted to apply at least one predefined policy to said first authentication response may be further adapted to suppress at least one authentication attribute. The first processor adapted to apply at least one predefined policy to said first authentication response may be further adapted to insert at least one user profile attribute.

The apparatus may further comprise a second processor that adapted to store said at least one user profile attribute wherein said at least one user profile attribute is defined by said user. The apparatus may further comprise a third processor that adapted to store said at least one predefined policy.

The apparatus may further comprise a third output adapted to display said generated second authentication response on a user device prior to transmitting said second authentication response to said service provider; and a third input adapted to receive an approval input wherein if said approval input is negative then said apparatus may further comprise a fourth processor adapted to alter said second authentication response based on said approval input.

The first input, second input, third input and fourth input may be the same inputs or different inputs or any combination thereof. The first output, second output and third output may be the same outputs or different outputs or any combination thereof. The first processor, second processor, third processor and fourth processor may be the same processors or different processors or any combination thereof.

The apparatus may be a computing device or an electronic device. The apparatus may be a user identity module. The apparatus may be implemented in hardware, software or a combination thereof.

According to a sixth aspect of the present invention there is provided a computer program product comprising computer readable executable code for: receiving a first authentication request from a service provider wherein said first authentication request requests authentication attributes relating to a user; transmitting a second authentication request to an identity provider; receiving a first authentication response from said identity provider wherein said first authentication response includes at least one authentication attribute relating to said user; applying at least one predefined policy to said first authentication response to generate a second authentication response; and transmitting said second authentication response to said service provider.

The computer program product may further comprise computer readable executable code for performing any or all of the functions in accordance with the aspects of the invention.

According to an seventh aspect of the present invention there is provided a method comprising the steps of: receiving an authentication request from an identity provider wherein said authentication request originates from a service provider; applying at least one predefined policy to said authentication request to generate an authentication response; and transmitting said authentication response to said identity provider in response to said authentication request.

Thus, an authentication request may be received from an identity provider which is based on an authentication request originating from a service provider wherein the originating authentication request may request authentication attributes relating to a user. The authentication request received from the identity provider may be the same as the authentication request originating from the service provider or may have been amended by the identity provider.

At least one predefined policy may be applied to the authentication request received from the identity provider. The predefined policies are the same as those described hereinabove and thus provide the ability to suppress at least one authentication attribute, may insert at least one user profile attribute or may both suppress at least one authentication attribute and also insert at least one user profile attribute. The authentication attributes and user profile attributes are the same as those described hereinabove.

The authentication response generated by applying the at least one predefined policy to the authentication request may then be transmitted to the identity provider.

The step of applying at least one policy to said authentication request may comprise the step of suppressing at least one authentication attribute that is stored at said identity provider. The step of suppressing at least one authentication attribute may include adding an instruction to suppress said at least one authentication attribute in said authentication response.

The step of applying at least one policy to said authentication comprises the step of inserting at least one user profile attribute into said authentication response.

The method may further comprise the steps of defining at least one user profile attribute; and storing said at least one user profile attribute. The method may further comprise the steps of defining said at least one predefined policy; and storing said at least one predefined policy.

The method may further comprise displaying the authentication response on a user device and receiving an approval input wherein if the approval input is negative then the authentication response may be altered based on the approval input.

The method may be implemented by a user identity module.

According to a eighth aspect of the present invention there is provided an apparatus comprising: an input adapted to receive an authentication request from an identity provider wherein said authentication request originates from a service provider; a processor adapted to apply at least one predefined policy to said authentication request to generate an authentication response; and an output adapted to transmit said authentication response to said identity provider in response to said authentication request.

According to a ninth aspect of the present invention there is provided an apparatus adapted to receive an authentication request from an identity provider wherein said authentication request originates from a service provider; apply at least one predefined policy to said authentication request to generate an authentication response; and transmit said authentication response to said identity provider in response to said authentication request.

The processor adapted to apply at least one predefined policy to said authentication request may be further adapted to suppress at least one authentication attribute that is stored at said identity provider. The at least one authentication attribute may be suppressed by adding an instruction or indication to suppress said at least one authentication attribute in said authentication response. The processor adapted to apply at least one predefined policy to said authentication request may be further adapted to insert at least one user profile attribute into said authentication response.

The apparatus may be an electronic device. The electronic device may be a user identity module.

According to an tenth aspect of the present invention there is provided a computer program product comprising computer readable executable code for: receiving an authentication request from an identity provider wherein said authentication request originates from a service provider; applying at least one predefined policy to said authentication request to generate an authentication response; and transmitting said authentication response to said identity provider in response to said authentication request.

The computer program product may further comprise computer readable executable code for performing any or all of the functions in accordance with the aspects of the invention.

According to an eleventh aspect of the present invention there is provided a method comprising the steps of receiving an authentication request from a user identity module wherein said authentication request requests authentication attributes relating to a user and originated from a service provider; generating an authentication response wherein the authentication response includes at least authentication attribute relating to the user and transmitting the authentication response to the user identity module.

According to a twelfth aspect of the present invention there is provided an apparatus comprising an input adapted to receive an authentication request from a user identity module wherein said authentication request requests authentication attributes relating to a user and originated from a service provider; a processor adapted to generate an authentication response wherein the authentication response includes at least authentication attribute relating to the user and an output adapted to transmit the authentication response to the user identity module.

According to a thirteenth aspect of the present invention there is provided an apparatus wherein the apparatus is adapted to receive an authentication request from a user identity module wherein said authentication request requests authentication attributes relating to a user and originated from a service provider; generate an authentication response wherein the authentication response includes at least authentication attribute relating to the user and transmit the authentication response to the user identity module.

The apparatus may be a computing device. The apparatus may be a server wherein the server may be operated by a public identity provider. The apparatus may be adapted using software, hardware or a combination thereof.

According to a fourteenth aspect of the present invention there is provided a computer program product comprising computer readable executable code for receiving an authentication request from a user identity module wherein said authentication request requests authentication attributes relating to a user and originated from a service provider; generating an authentication response wherein the authentication response includes at least authentication attribute relating to the user and transmitting the authentication response to the user identity module.

The computer program product may further comprise computer readable executable code for performing any or all of the functions in accordance with the aspects of the invention.

According to a fifteenth aspect of the present invention there is provided a method comprising the steps of receiving a first authentication request from a service provider wherein the authentication request requests authentication attributes relating to a user; transmitting a second authentication request to a user identity module; receiving a first authentication response from the user identity module wherein the first authentication response includes at least one user profile attribute and/or an indication to suppress at least one authentication attribute; generating a second authentication response based on said first authentication response and at least one authentication attribute and transmitting said second authentication response to the service provider in response to the first authentication request.

According to a sixteenth aspect of the present invention there is provided an apparatus comprising a first input adapted to receive a first authentication request from a service provider wherein the authentication request requests authentication attributes relating to a user; a first output adapted to transmit a second authentication request to a user identity module; a second input adapted to receive a first authentication response from the user identity module wherein the first authentication response includes at least one user profile attribute and/or an indication to suppress at least one authentication attribute; a processor adapted to generate a second authentication response based on said first authentication response and at least one authentication attribute and a second output adapted to transmit said second authentication response to the service provider in response to the first authentication request.

The first input and the second input may be the same input or different inputs. The first output and the second output may be the same output or different outputs.

According to a seventeenth aspect of the present invention there is provided an apparatus wherein the apparatus is adapted to receive a first authentication request from a service provider wherein the authentication request requests authentication attributes relating to a user; transmit a second authentication request to a user identity module; receiving a first authentication response from the user identity module wherein the first authentication response includes at least one user profile attribute and/or an indication to suppress at least one authentication attribute; generate a second authentication response based on said first authentication response and at least one authentication attribute and transmit said second authentication response to the service provider in response to the first authentication request.

The apparatus may be adapted by software, hardware or any combination thereof. The apparatus may be a computing device. The apparatus may be a server wherein the server may be operated by a public identity provider.

According to an eighteenth aspect of the present invention there is provided a computer program product comprising computer readable executable code for receiving a first authentication request from a service provider wherein the authentication request requests authentication attributes relating to a user; transmitting a second authentication request to a user identity module; receiving a first authentication response from the user identity module wherein the first authentication response includes at least one user profile attribute and/or an indication to suppress at least one authentication attribute; generating a second authentication response based on said first authentication response and at least one authentication attribute and transmitting said second authentication response to the service provider in response to the first authentication request.

The computer program product may further comprise computer readable executable code for performing any or all of the functions in accordance with the aspects of the invention.

Embodiments of the present invention will now be described, by way of example only, and with reference to the accompanying drawings, in which:

FIG. 1 is a block diagram demonstrating the use of identity management in the prior art.

FIG. 2 is a block diagram in accordance with many embodiments of the invention.

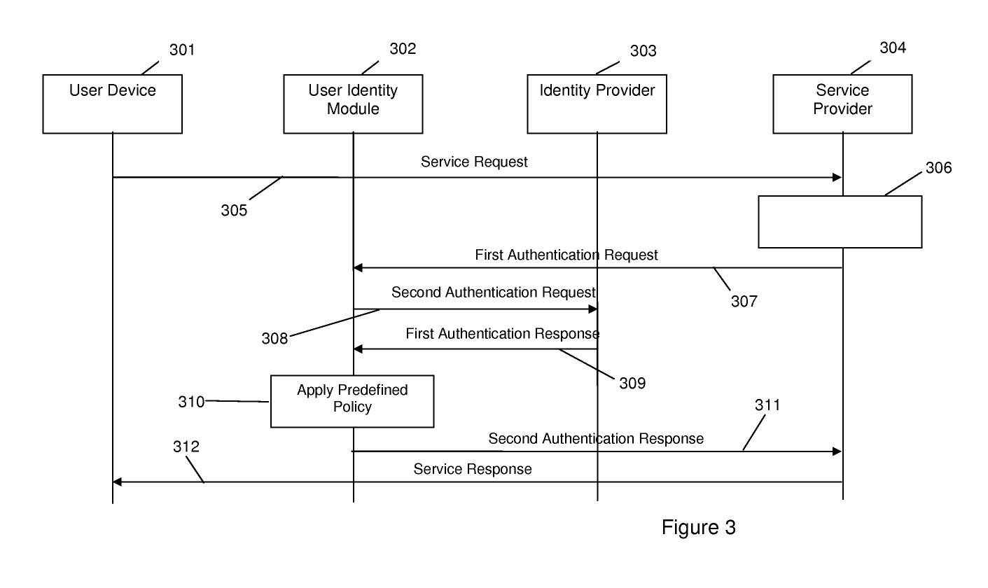

FIG. 3 shows a message sequence in accordance with many embodiments of the invention.

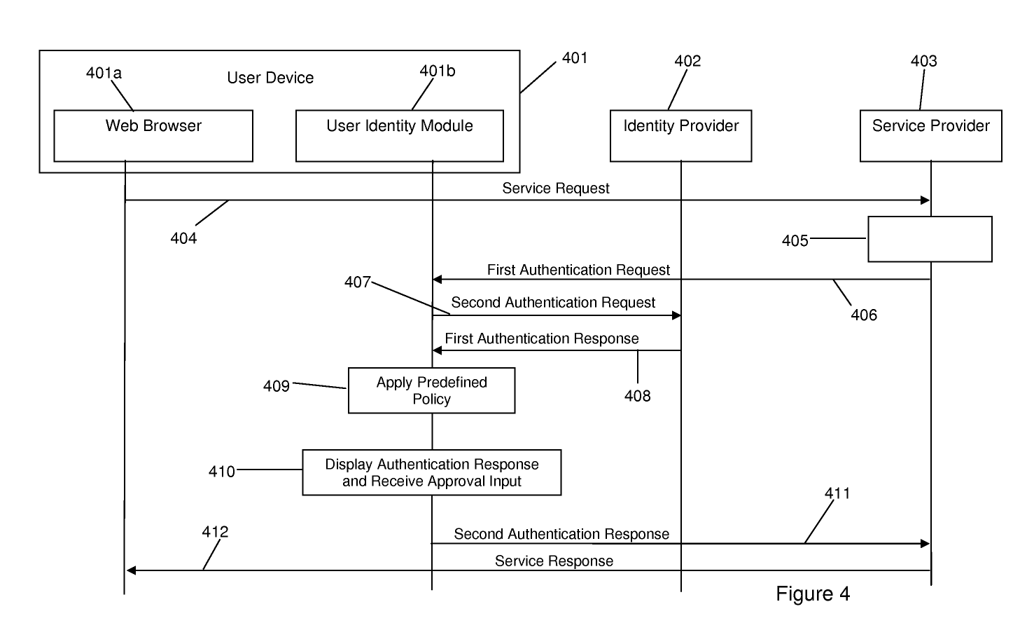

FIG. 4 shows a message sequence in accordance with many embodiments of the invention.

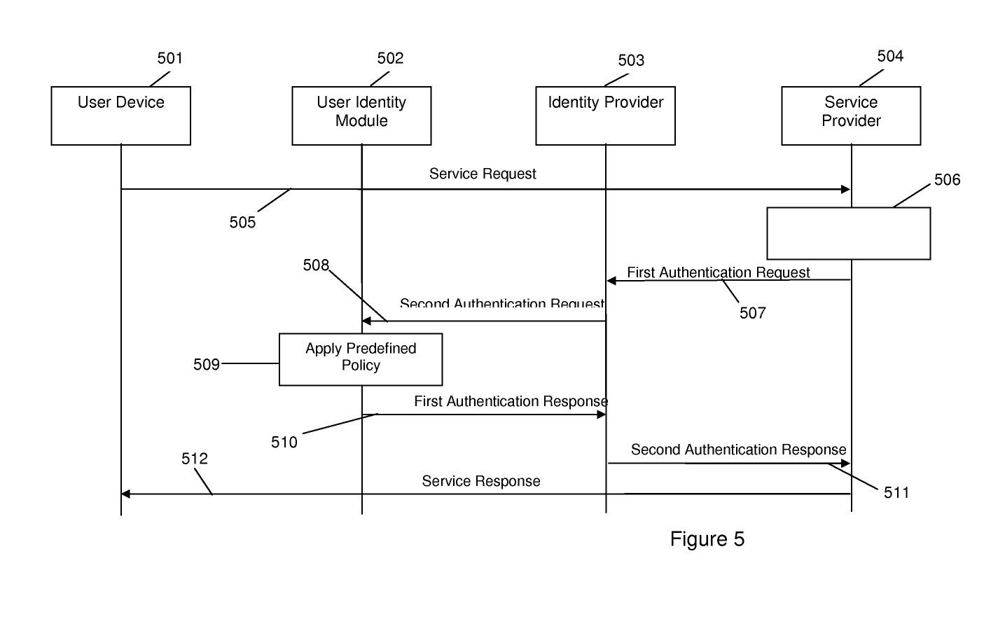

FIG. 5 shows a message sequence in accordance with many embodiments of the invention.

FIG. 2 is a block diagram of a system 201 that is in accordance with many of the embodiments of the present invention. The system 201 may comprise a user device 202, e.g. a computer, mobile device and so on, a user identity module 203, a public identity provider 204 and a service provider 205. In this system the user device 202 and the user identity module 203 can communicate and interact with the public identity provider 204 and the service provider 205 via a network 206, such as the Internet. Similarly, the public identity provider 204 and the service provider 205 can also communicate and interact with each other via the network 206 or via the user device 202 and user identity module 203.

The user identity module 203 may be integrated with the user device 202. Alternatively, the user identity module 203 may be implemented on a separate apparatus, e.g. a computing or electronic device, which may reside at the premises of the user or on a user's home network. In a further alternative, the user identity module 203 may be integrated with an apparatus already forming part of the user's home network, for example, a network router.

The user identity module 203 is provided as a user controlled personal identity provider. The user identity module 203 may operate in conjunction with at least one third party public identity provider 204 to enable the user to control and verify both secure authentication attributes (e.g. address, bank details, passwords etc) as well as maintain and provide non-authority proven data (e.g. shoe size, job title, current TV channel etc). However, this raises a further problem of how to deploy effectively two identity providers (third party and user identity module) where the first, the third party public identity provider 204, is an officially trusted identity provider and the second, the user identity module 203, being user maintained and user verified data. Many of the embodiments of the present invention seek to address this additional problem along with the ones outlined hereinabove.

The user identity module 203 will reside at the user's premises or on the user's network, managed by the user and used to control the provisioning of the user's authentication data and user profile data to other entities (e.g. service providers 205).

The user may also wish to maintain a store of user profile data which either the user does not want to store at the public identity provider 204, for example, bank account details if the bank account details are not required by any service provider for authentication purposes, or should not store at the public identity provider 204, for example, non-authority proven user profile data such as shoe size, job title etc, or due to the nature of the data it cannot be stored permanently at the identity provider such as the current TV channel being viewed. Thus, the user may define attributes as part of the user profile data that can be stored and maintained by the user. The user profile data may then be used to enhance the authentication process in order to provide additional information about the user to the service provider for the service the user wishes to use. By enabling the user to store and maintain their own user profile data then the user would not have to manually enter the user profile data to a particular service each and every time that the user wishes to use that service.

Accordingly, as the user maintains the user profile data then the user profile data may not be authority proven. However, the service provider 205 can assume that the user would only maintain valid user profile data and therefore trust the user profile data supplied by the user identity module 203. For example, the user may use an online shoe shopping service and at the point of authenticating the user to the service provider the user may wish to automatically supply the user's shoe size. The user's shoe size can not be authority proven and therefore the service provider will have to trust that the user will supply their correct shoe size as part of the authentication process. Another example could be that the user does not wish to disclose their actual postal address but instead supply a post box number to an online ordering service. Again, the service provider 205 will need to trust that the user will provide a correct post box number.

The user profile data may therefore comprise a series of attributes that the user may define and maintain. For any particular service none, one or more of the attributes from the attributes defined and maintained may be provided to the service provider depending on the user defined policies.

The user profile data may be stored locally in the user identity module 203. Alternatively, the user profile data may be stored in a repository operatively connected to the user identity module 203. For example, the user profile data may be stored separately to the user identity module 203 but the user identity module 203 stores a reference or a link to the repository of the user maintained user profile data.

The user profile data may be encrypted wherever the user profile data is stored in order to ensure the user's privacy and security.

The public identity provider 204 will store user authentication data that is required to be authority proven and/or provided by a trusted source in order to authenticate a user to the service provider 205 for a particular service. For example, if the service is online banking then the service provider may require the bank account details to be provided by a trusted source, e.g. the public identity provider 204, and therefore the public identity provider 204 will store the bank account details as part of the user's authentication data. However, the user will want to ensure that their bank account details, if stored at the public identity provider 204, are not provided to any other service in order to maintain the user's privacy and security.

The authentication data stored at the public identity provider may comprise a series of attributes that may be used or required by the service providers for the different services which the user has signed up to or registered for in order to authenticate the user. Accordingly, when requested to provide authentication data relating to a user, the public identity provider will provide only those authentication data attributes that are necessary to authenticate the user for a particular service.

The user identity module 203 may also include user defined policies for managing and controlling the process of authenticating the user to the service provider 205. The user defined policies enable a user to specify and control the user authentication data stored at the public identity provider 204 which is provided to a particular service provider 205 for a particular service. In other words, the user can maintain control of the user authentication data that the public identity provider 204 would transmit to the service provider 205 to authenticate the user. Furthermore, the user defined policies at the user identity module 203 may also specify any user profile data that is to be included or inserted to enhance the authentication process for a particular service.

The user will define the policies and store them in the user identity module. In other words, the policies are predefined so that they may be applied to the authentication data forming an authentication response as and when required. The user may define and store as many policies as the user requires in order to provide the user control over the data provided to service providers for the services the user has registered for.

A user defined policy may include a set of rules or instructions that may be applied when a particular service is requested or a particular service provider is involved. For example, a user defined policy may be that if I am watching a certain TV channel, then my credit card information should not be given out by the public identity provider. A further user defined policy may be that if there is a person at the bathroom and the TV is running, please report my presence status as “away”. Another user defined policy may be to report back my identity and legal age verification, if my key is at home and I am logged into my computer with my account. Thus, either stealing the key or the password will not sufficient for anyone else to pretend to be the user.

As will be appreciated, any number of user defined polices may be predefined and stored by the user. Moreover, the user defined policies may include any rules or instructions relevant to any service or service provider that the user uses or has registered for.

If the user identity module is implemented as part of the user's device 202 then the user can maintain and store the user profile data and the user defined policies directly on the user device 202. However, if the user identity module 203 is implemented as a device, or integrated with a device on the user's home network and therefore separate to the user's device 202, then the user will interact with the user identity module 203 so that the user can define and store user profile data and policies. If the user profile data is stored externally with a link to the user profile data stored in the user identity module 203 then the user device 202 will interact with the external storage or repository either directly or via the user identity module 203.

In order to enable the user identity module 203 and the public identity provider 204 to cooperate and work in conjunction to authenticate a user to a service provider 205 for a requested service the user identity module 203 will monitor the data traffic between the service provider 205 and the public identity provider 204 in the network. In other words, the user identity module 203 may act as a “middle-man” or a supervisor of the authentication process between the requestor (e.g. the service provider 205) and the public identity provider 204. Thus, the user is able to control and verify the user's authentication data provided by the public identity provider 204 before it is transmitted to the service provider 205 which improves and enhances the security and privacy of the user's authentication data.

Two examples of the implementation and operation of identity management using a user identity module in accordance with many of the embodiments of the present invention will now be described, by way of example only, and with reference to FIGS. 3 and 4.

FIG. 3 shows a message sequence for authenticating a user to a service provider for a service the user has requested.

When a user wishes to use a service provided by a service provider 304 the user, via a user device 301, will transmit 305 a service request message to the service provider 304. If the service provider 304 requires the user to be authenticated then the service provider may discover 306 which identity provider will be used to authenticate the user.

The identity provider discovery 306 process is not essential to the embodiments of the present invention as there are various discovery techniques available to the service provider 304. For example, the service request message transmitted from the user device 301 may identify the identity provider to use. Alternatively, when the user signs up to or registers for a service the user may indicate the identity provider the service provider is to use.

In many of the embodiments of the present invention the identity provider “discovered” by the service provider 304 will be the user identity module 302. The service provider 304 will then transmit 307 an authentication request to the user identity module 302.

The user identity module 302 will not store or own the authority proven user authentication data that is necessary to complete at least part of the authentication process to authenticate the user to the service provider 304. The service provider 304, in order to authenticate a user, needs to receive the necessary authentication data relating to the user from a trusted source so that the service provider 304 can trust that the user requesting access is the true user that registered for the service. The trusted source is typically the public identity provider 303 and therefore the public identity provider 303 owns the authentication data (comprising at least one authentication attribute) relating to the user.

The user identity module 302 will obtain the relevant user authentication data from the public identity provider 303 by transmitting an authentication request to the public identity provider 303. The authentication request transmitted to the public identity provider 303 may be identical to the authentication request received at the user identity module 302 or the user identity module 302 may alter the authentication request received before transmitting it to the public identity provider 303.

The public identity provider 303 will transmit an authentication response 308 to the user identity module 302 where the authentication response includes authentication data attributes relating to the user that are considered necessary to authenticate the user to the service provider 304. As mentioned hereinabove, the public identity provider 303 stores authentication data relating to a user where the authentication data may comprise one or more attributes. The authentication data may include various attributes necessary to authenticate the user to each of the different services, provided by one or more service providers, the user has registered for. Accordingly, the authentication response from the public identity provider 303 will include only those authentication attributes, from the whole authentication data relating to a user, necessary to authenticate the user with the particular requested service.

Before transmitting the authentication response to the user identity module 302 the public identity provider 303 may apply any user defined policies stored at the public identity provider 303 along with any public identity provider policies to the authentication response, e.g. the authentication attributes relating to the user, relevant to the service provider 304 for the service requested.

The user authentication data attributes in the authentication response from the public identity provider 303 may be digitally signed in order to prove that it originated from the public identity provider 303 and therefore can be trusted. The user authentication data attributes provided by the public identity provider 303 may be digitally signed as a whole or alternatively, each individual attribute forming the authentication response may be individually digitally signed.

On receipt of the authentication response from the public identity provider 303, the user identity module 302 will apply the relevant user defined policies stored in the user identity module 302 to the user authentication data attributes provided by the public identity provider 303. For example, the user defined policies at the user identity module 302 may suppress, remove or delete particular user authentication data attributes from the authentication response that is to be transmitted to the service provider for the particular service. Similarly, the user defined policies may enhance the user authentication response received from the public identity provider 303 by inserting user profile data attributes maintained by the user.

The user may generate any number of policies which are predefined and stored in the user identity module 302. The predefined policies may be applied to all received authentication responses from the public identity provider 303 or may be applied selectively based on the defined policy. For example, a particular policy may be defined to be applied when the authentication response is for a particular service, when the authentication response is to be transmitted to a particular service provider or when particular authentication attributes relating to the user are present in the authentication response received from the public identity provider.

Thus, as the user can define policies that suppress, remove or delete user authentication data attributes from being provided to one or more service providers in respect of one or more services then the user maintains control over the distribution or use of the user authentication data thereby improving the user's privacy and security. The user defined policies also enable a user to specify when to insert additional user profile data in the authentication response that is to be transmitted to a service provider 304. Accordingly, the user profile data maintained by the user can be automatically provided to the service provider so that the user does not have to manually enter the additional user profile data each and every time the user wishes to use a particular service. Moreover, by enabling a user, via user defined policies, to add any type of user profile attributes to the authentication response then more interactive services may be developed.

As mentioned above, the user authentication data attributes provided by the public identity provider 303 may either be digitally signed as a single block or each attribute in the authentication response may be individually digitally signed.

In the case that each attribute in the authentication response provided by the public identity provider 303 is individually digitally signed then the user defined policies can suppress, remove or delete individual attributes from the authentication response without breaking the digital signature of the remaining user authentication data attributes provided by the public identity provider in the authentication response.

In the case that all of the user authentication attributes in the authentication response provided by the public identity provider 303 are digitally signed as a single block then in order suppress, remove or delete particular attributes in accordance with one or more user defined policies the user identity module 302 may either suppress, remove or delete the complete block of attributes or may break the digital signature, suppress, remove or delete the relevant user authentication data attributes and then digitally re-sign the block of attributes in the authentication response.

In both cases, if the user defined policies in the user identity module 302 specify that for the service being requested additional user profile data attributes from the user maintained profile data store should be inserted to enhance the authentication response to the service provider 304 then the user identity module 302 will insert the appropriate user profile attributes. The user identity module 302 may then digitally sign the user profile attributes itself.

The user identity module 302 transmits an authentication response 311 to the service provider once the relevant user defined policies have been applied. If the authentication response includes user authentication data and/or user profile data that has been digitally signed by the user identity module 302 then it will be dependent on the service provider 304 to decide whether to accept and trust any data digitally signed by the user identity module 302.

The service provider will then respond 312 to the original service request 305 from the user device 301 to either provide the user access to the requested service or deny the user access to the requested service.

The example described hereinabove shows an exemplary way in which the user can maintain control over the provisioning of user authentication data and additional user profile data to a service provider 304. The user maintains the control over the provisioned data by defining policies in the user identity module 302 which may then be used to ensure that only the user authentication data and user profile data that the user wants to provide to a particular service provider 304 for a particular service is present in the authentication response to the service provider 304. Thus, the user can be sure that only the user authentication data and user profile data they wish to disclose is provided to a service provider for a given service thereby ensuring that the user's privacy and security is maintained.

The above example also shows how the user can also use the defined policies stored at the user identity module to enhance the authentication response to the service provider to include user profile data that the user maintains. Thus, each time a user wishes to access and use a particular service then this additional user profile data can be supplied automatically without requiring the user to manually enter the user profile data each and every time they access or request the service. The user defined policies at the user identity module may identify that the authentication request is for a particular service and insert the appropriate and relevant data automatically as defined by the user. As the user has defined and managed the user profile data stored locally then the user's privacy will also be maintained.

The above described example shows how the user identity module and an external public identity provider may work in cooperation to authenticate a user to a service provider for a particular service whilst improving the user's privacy and giving the user control over the user authentication data provided to a service provider. As mentioned hereinabove, the user identity module may be implemented as part of or integrated with a user device, implemented as part of or integrated with other logic or device on the user's home network, e.g. a router, or implemented as a separate device located on or operatively attached to the user's home network.

However, in the case that the user identity module is part of or integrated with a user device, e.g. a computer, mobile device, etc, then the invention can be further enhanced to provide the user with the ability to view the user profile data that is to be transmitted to the service provider. Thus, the user will become the final decision maker in the process after any user defined policies have been applied with the ability to accept, prevent or change the user authentication data and any user profile data present in the authentication response before it is transmitted to a service provider. This provides the user with greater flexibility and greater control as the user can make ad-hoc changes to the user authentication data and user profile data to be provided to the service provider without the need to alter the user defined policies. The user may also be provided with a visual display of the authentication response after the authentication response has been transmitted to the service provider.

This example of the user identity module being part of or integrated with the user's device will now be described with reference to FIG. 4.

FIG. 4 shows a message sequence between a user device 401, a public identity provider 402 and a service provider 403. The user device 401 may comprise a web browser 401a and a user identity module 401b.

The user, via the web browser 401a on the user device 401, transmits a service request 404 to a service provider 403 for a service that the user wishes to access which is offered by the service provider 403.

The process of this example initially follows the same steps as described hereinabove in relation to FIG. 3 and therefore the same steps will not be described in detail.

Firstly, the service provider 403 may perform an identity provider discovery in order to identify the identity provider that will authenticate the user to the service provider 403. As described hereinabove in relation to FIG. 3, the identity provider discovery process is not essential to the present invention and can be performed in a variety of ways. For example, the service request may identify the correct identity provider or the user on registering to the particular service or service provider may provide the identity provider information and so on.

In this present example, the service provider 403 will discover or identify the user identity module 401b as being initial “identity provider” to contact.

The service provider may then transmit an authentication request 406 to the user identity module 401b. As the user identity module 401b does not own the user authentication data the user identity module 401b transmits an authentication request 407 to the public identity provider 402. The public identity provider 402 responds with an authentication response 408 to the user identity module 401b. As described hereinabove, the public identity provider 402 will apply any user defined policies stored at the public identity provider 402 along with any public identity provider policies before returning the authentication response.

The user identity module 401b, on receipt of the authentication response from the public identity provider 402, will apply or enforce 409 any user defined policies stored at the user identity module 401b in order to suppress, remove or delete any number of the user authentication attributes in the authentication response provided by the public identity provider 402 and/or to insert user profile data attributes stored and maintained by the user as described in relation to FIG. 3.

This example differs from the example described in relation to FIG. 3 in that in step 410 the user identity module 401b displays on the user device 401 the user authentication data attributes and the user profile data attributes that form the generated authentication response to be transmitted to the service provider 403. The user can then review the user authentication data attributes and the user profile data attributes displayed on the user device 401 and make the final decision as to whether one or more of the attributes should be suppressed, removed or deleted from the generated authentication response. If the user provides negative approval input then the authentication response may be amended or altered based on the negative approval input. For example, if the user inputs that they wish a particular authentication attribute to be removed or deleted from the authentication response then the user identity module may proceed to remove the identified authentication attribute from the authentication response

If the user provides positive approval input or if any alterations or amendments based on the negative approval input have been made, then the authentication response can be transmitted 411 to the service provider 403.

If the service provider accepts the authentication response 411 then the service provider will grant access to the service requested by the user. If the service provider does not accept the authentication response 411 then the service provider will deny access to the service requested by the user.

The service provider will inform the user of its decision to grant or deny access to the service by transmitting a service response 412 to the web browser 401a on the user device 401.

Accordingly, in many of the embodiments the user authentication data and any user profile data can be displayed to the user prior to and/or after the authentication response is transmitted to a service provider. The decision as to whether to display the attributes forming the authentication response to the user at any point in time may be specified by a user defined policy stored at the user identity module. For example, a user defined policy may specify that is particular user authentication data attributes are present in the authentication response or if a particular service provider is requesting the authentication of the user then the authentication response should be displayed to the user for final approval. Alternatively, the user identity module may always display the authentication response to the user for final approval before transmitting the authentication response to the service provider.

If the authentication response is displayed to the user prior to transmitting the authentication response to the service provider then the user will make the final decision as to the attributes of the authentication response (e.g. the user authentication data and the user profile data) that will be provided to the service provider. Thus, the user and the user device will become part of the chain of trust which in federated identity management is a topological description of entities which to varying degrees certify the correctness of the data provided to the next entity in the chain. The user, by becoming part of the chain of trust, is able to improve and enhance the data which the next entity in the chain of trust (e.g. the service provider) receives from, and about, the user.

In the above described example, the user identity module was integrated with the user device. However, as a person skilled in the art will appreciate, a user identity module that is implemented as separate to the user device may be able to interface with the user device in order to be able to display the authentication response either prior to or after transmission to the service provider as well as receive user approval input from the user device.

In the above described embodiments, the service provider in response to receiving the service request message from a user device “discovers” the user identity module as the identity provider to initially contact. However, in many of the embodiments the service provider may alternatively “discover” the public identity provider as the identity provider to initially contact. This embodiment will now be described, by way of example only, and with reference to FIG. 5.

A user, via a user device 501, may transmit 505 a service request message to the service provider 504 when the user wishes to use or access a service. If the service provider 504 requires the user to be authenticated then the service provider 504 may discover 506 which identity provider will be used to authenticate the user.

The identity provider discovery process 506 is not essential to the embodiments of the present invention as there are various discovery techniques available to the service provider. For example, the service request message may identify the identity provider to use. Alternatively, when the user registers for a service the user may indicate the identity provider that the service provider is to use.

In this example, the identity provider discovered by the service provider 504 will be the public identity provider 503. The service provider 504 will then transmit an authentication request 507 to the public identity provider 503.

The public identity provider 503 on receipt of the authentication request 507 may identify that the user, whom is to be authenticated, has or is operating a user identity module 502. If the user is operating a user identity module 502 then the user may have informed the public identity provider 503 to interact with the user identity module 502 when any authentication request is received at the public identity provider 503 or if the authentication request received at the public identity provider 503 originates from a particular service provider or is in relation to a particular service. In another example, the service request message 505 transmitted to the service provider 504 from the user device 501 may include an indication that the user is operating a user identity module 502 such that when the authentication request 507 is transmitted to the public identity provider 503 from the service provider 504 then the authentication request also includes the indication to the public identity provider 503 that the user is operating a user identity module 502.

The public identity provider 503 on determining or identifying that the user operates a user identity module 502 transmits an authentication request 508 to the user identity module 502. The authentication request 508 transmitted to the user identity module 502 from the public identity provider 503 may be the same or different to the authentication request 507 transmitted to the public identity provider 503 from the service provider 504.

The user identity module 502 may then apply at least one user defined policy 509 to the authentication request 508 received from the public identity provider 503. As described hereinabove, the user identity module 502 will not store or own the authority proven authentication data relating to the user that is necessary to complete at least part of the authentication process to authenticate the user to the service provider 504.

The predefined user defined policies that may be applied to the authentication request 508 may generate an authentication response which may include user profile attributes that are maintained at the user identity module 502, e.g. the current TV channel, location of the user, shoe size of the user and so on, may include instructions to the public identity provider 503 not to provide or suppress particular authentication attributes stored at the public identity provider 503, e.g. credit card details, or may include both user profile attributes and instructions to the public identity provider 503 not to provide particular authentication attributes.

The user identity module 502 may then transmit the authentication response 510 to the public identity provider 503. On receipt of the authentication response 510 the public identity provider may then generate an authentication response to the service provider 504 based on the authentication data stored at the public identity provider 503 and the information received in the authentication response from the user identity module 502.

The public identity provider 502 may then transmit the authentication response 511 to the service provider 504 in response to the original authentication request from the service provider 504. As the public identity provider 503 is transmitting the authentication response to the service provider 504 then the service provider 504 will trust the attributes in the authentication response including both the authentication attributes from the public identity provider 503 and the user profile attributes, if any, provided by the user identity module 502.

The service provider 504 may then respond 512 to the original service request 505 from the user device 501 to either provide the user with access to the requested service or deny the user access to the requested service.

Accordingly, in the above described embodiments a user can maintain control over the provisioning of authentication data relating to the user stored at the public identity provider to a service provider. Furthermore, the user can also provide additional user profile data as part of the authentication response to the service provider which enables more interactive and a greater range of services to be provided.

In many of the embodiments an exemplary implementation may be based on Security Assertion Markup Language (SAML). SAML is an XML (eXtensible Markup Language) standard for exchanging authentication and authorisation data between security domains. For example, SAML is used for exchanging assertion data between an identity provider (a producer of assertions) and a service provider (a consumer of assertions). SAML is a specification defined by the OASIS (Organization for the Advancement of Structured Information standards). In accordance with the SAML protocol the authentication requests and responses may be implemented in the form of an HTTP redirect.

While preferred embodiments of the invention have been shown and described, it will be understood that such embodiments are described by way of example only. Numerous variations, changes and substitutions will occur to those skilled in the art without departing from the scope of the present invention as defined by the appended claims. For example, although the invention has been described with reference to the SAML standard, other possible implementations are possible. Accordingly, it is intended that the following claims cover all such variations or equivalents as fall within the spirit and the scope of the invention.

1. A method comprising the steps of:
receiving a first authentication request for authentication attributes relating to a user wherein said first authentication request originates from a service provider;
generating a first authentication response based on at least one predefined policy applied by a user identity module and at least one authentication attribute stored at an identity provider; and
transmitting said first authentication response to said service provider in response to said first authentication request.

2. The method as claimed in claim 1 in which said first authentication request is received at said user identity module; said method further comprises the steps of:
transmitting from said user identity module a second authentication request to said identity provider;
receiving at said user identity module a second authentication response from said identity provider;
applying in said user identity module at least one predefined policy to said second authentication response to generate said first authentication response; and
transmitting from said user identity module said first authentication response to said service provider.

3. The method as claimed in claim 1 in which said first authentication request is received at said identity provider; said method further comprises the steps of:
transmitting from said identity provider a second authentication request to said user identity module;
applying in said user identity module said at least one predefined policy to said second authentication request to generate a second authentication response;
transmitting from said user identity module said second authentication response to said identity provider;
generating at said identity provider said first authentication response; and
transmitting from said identity provider said first authentication response to said service provider.

4. The method as claimed in claim 1 further comprising the steps of:
defining said at least one predefined policy; and
storing said at least one predefined policy.

5. The method as claimed in claim 1 in which said at least one predefined policy inserts at least one user profile attribute maintained by said user identity module.

6. The method as claimed in claim 5 further comprising the steps of:
defining at least one user profile attribute wherein said at least one user profile attribute is maintained by said user identity module; and
storing said at least one user profile attribute.

7. The method as claimed in claim 1 in which said at least one predefined policy suppresses at least one authentication attribute stored at said identity provider.

8. A system comprising an identity provider and a user identity module wherein said identity provider and said user identity module are operatively connected; said system is adapted to:
receive an authentication request for authentication attributes relating to a user wherein said authentication request originates from a service provider;
generate an authentication response based on at least one predefined policy applied by said user identity module and at least one authentication attribute stored at said identity provider; and
transmit said authentication response to said service provider in response to said authentication request.

9. The system as claimed in claim 8 in which said system is further adapted to:
receive said first authentication request at said user identity module;
transmit from said user identity module a second authentication request to said identity provider;
receive at said user identity module a second authentication response from said identity provider;
apply in said user identity module at least one predefined policy to said second authentication response to generate said first authentication response; and
transmit from said user identity module said first authentication response to said service provider.

10. The system as claimed in claim 8 in which said system is further adapted to:
receive said first authentication request at said identity provider;
transmit from said identity provider a second authentication request to said user identity module;
apply in said user identity module said at least one predefined policy to said second authentication request to generate a second authentication response;
transmit from said user identity module said second authentication response to said identity provider;
generate at said identity provider said first authentication response; and
transmit from said identity provider said first authentication response to said service provider.

11. A method comprising the steps of:
receiving a first authentication request from a service provider wherein said first authentication request requests authentication attributes relating to a user;
transmitting a second authentication request to an identity provider;
receiving a first authentication response from said identity provider wherein said first authentication response includes at least one authentication attribute relating to said user;
applying at least one predefined policy to said first authentication response to generate a second authentication response; and
transmitting said second authentication response to said service provider in response to said first authentication request.

12. The method as claimed in claim 11 in which said step of applying at least one predefined policy to said first authentication response comprises the step of suppressing at least one authentication attribute.

13. The method as claimed in claim 11 in which said step of applying at least one predefined policy to said first authentication response comprises the step of inserting at least one user profile attribute.

14. The method as claimed in claim 11 further comprising the steps of:
defining at least one user profile attribute; and
storing said at least one user profile attribute.

15. The method as claimed in claim 11 further comprising the steps of:
defining said at least one predefined policy; and
storing said at least one predefined policy.

16. The method as claimed in claim 11 further comprising the steps of:
displaying said generated second authentication response on a user device prior to transmitting said second authentication response to said service provider; and
receiving an approval input wherein if said approval input is negative then said method further comprises the step of:
altering said second authentication response based on said approval input.

17. An apparatus comprising:
a first input adapted to receive a first authentication request from a service provider wherein said first authentication request requests authentication attributes relating to a user;
a first output adapted to transmit a second authentication request to an identity provider;
a second input adapted to receive a first authentication response from said identity provider wherein said first authentication response includes at least one authentication attribute relating to said user;
a first processor adapted to apply at least one predefined policy to said first authentication response to generate a second authentication response; and
a second output adapted to transmit said second authentication response to said service provider.

18. The apparatus as claimed in claim 17 in which said first processor adapted to apply at least one predefined policy to said first authentication response is adapted to suppress at least one authentication attribute.

19. The apparatus as claimed in claim 17 in which said first processor adapted to apply at least one predefined policy to said first authentication response is adapted to insert at least one user profile attribute.

20. The apparatus as claimed in claim 17 further comprising a second processor is adapted to store said at least one user profile attribute wherein said at least one user profile attribute is defined by said user.

21. The apparatus as claimed in claim 17 further comprising:
a third output adapted to display said generated second authentication response on a user device prior to transmitting said second authentication response to said service provider; and
a third input adapted to receive an approval input wherein if said approval input is negative then said apparatus further comprises:
a third processor adapted to alter said second authentication response based on said approval input.

22. A computer program product comprising computer readable executable code for:
receiving a first authentication request from a service provider wherein said first authentication request requests authentication attributes relating to a user;
transmitting a second authentication request to an identity provider;
receiving a first authentication response from said identity provider wherein said first authentication response includes at least one authentication attribute relating to said user;
applying at least one predefined policy to said first authentication response to generate a second authentication response; and
transmitting said second authentication response to said service provider.

23. A method comprising the steps of:
receiving an authentication request from an identity provider wherein said authentication request originates from a service provider;
applying at least one predefined policy to said authentication request to generate an authentication response; and
transmitting said authentication response to said identity provider in response to said authentication request.

24. The method as claimed in claim 23 in which said step of applying at least one policy to said authentication request comprises the step of suppressing at least one authentication attribute that is stored at said identity provider.

25. The method as claimed in claim 23 in which said step of applying at least one policy to said authentication comprises the step of inserting at least one user profile attribute into said authentication response.

26. The method as claimed in claim 23 further comprising the steps of:
defining at least one user profile attribute; and
storing said at least one user profile attribute.

27. The method as claimed in claim 23 further comprising the steps of:
defining said at least one predefined policy; and
storing said at least one predefined policy.

28. An apparatus comprising:
an input adapted to receive an authentication request from an identity provider wherein said authentication request originates from a service provider;
a processor adapted to apply at least one predefined policy to said authentication request to generate an authentication response; and
an output adapted to transmit said authentication response to said identity provider in response to said authentication request.

29. The apparatus as claimed in claim 28 in which said processor adapted to apply at least one predefined policy to said authentication request is further adapted to suppress at least one authentication attribute that is stored at said identity provider.

30. The apparatus as claimed in claim 28 in which said processor adapted to apply at least one predefined policy to said authentication request is further adapted to insert at least one user profile attribute into said authentication response.

31. A computer program product comprising computer readable executable code for:
receiving an authentication request from an identity provider wherein said authentication request originates from a service provider;
applying at least one predefined policy to said authentication request to generate an authentication response; and
transmitting said authentication response to said identity provider in response to said authentication request.
